(19) United States
(12) Patent Application Publication
(10) Pub. No.: US 2007/0036157 A1
(43) Pub. Date: Feb. 15, 2007

(54) Medium recording connection switching program, electronic conference system and connection switching method

(76) Inventors: Yoshiki Watanabe, Tokyo (JP); Kazunori Horikiri, Tokyo (JP); Eriko Tamaru, Yokohama-shi (JP); Masatomi Inagaki, Tokyo (JP)

Correspondence Address: GAUTHIER & CONNORS, LLP, 225 FRANKLIN STREET, SUITE 2300, BOSTON, MA, 02110, US

(21) Appl. No.: 11/400,887

(22) Filed: Apr. 10, 2006

(30) Foreign Application Priority Data
Apr. 27, 2005 (JP) 2005-128932

(51) Int. Cl. H04N 7/14; H04L 12/28; H04M 11/00

(52) U.S. Cl. 370/389; 348/14.01; 348/14.11; 379/90.01

(57) ABSTRACT

A connection switching program to perform a function of a first information communication terminal included in an electronic conference system includes the first and a second information communication terminal; a first mobile communication terminal; a second mobile communication terminal that has identification information to be held by the first mobile communication terminal; and a storage unit that stores identification information of each of the information communication terminals in associated with identification information of each of the mobile communication terminals; the function includes obtaining the identification information of the second mobile communication terminal from the first mobile communication terminal; obtaining the identification information of the second information communication terminal which corresponds to obtained the identification information of the second mobile communication terminal from the storage unit; and connecting with the second information communication terminal through a communication network, based on the obtained identification information of the second information communication terminal.

### PRIORITY INFORMATION

This application claims priority to Japanese Patent Application No. 2005-128932 filed on Apr. 27, 2005, which is incorporated herein by reference in its entirety.

### BACKGROUND

1. Technical Field

The present invention generally relates to the control of information communication terminals constituting an electronic conference system, and more particularly to the switching control of communication performed between mobile communication terminals and information communication terminals.

2. Related Art

A related art switching control method is described based on FIG. 10. The method is one for switching a state in which plural voice communication terminals are connected with each other to a state in which plural information communication terminals such as electronic conference terminals are connected with each other.

FIG. 10 is a view showing communication terminals and communication channels which are used in communication between two bodies. A user A has a telephone 110, which is a voice communication terminal, and an apparatus 140, which is an information communication terminal. The telephone 110 is connected with the apparatus 140 through a peripheral equipment connection unit 130. Similarly, a user B also has a telephone 112 and an apparatus 142, and the telephone 112 and the apparatus 142 are connected with each other through a peripheral equipment connection unit 132. In addition, Bluetooth, serial connection or the like can be cited as an example of each peripheral equipment connection unit.

The telephones 110 and 112 are connected with each other through a primary channel 160. On the other hand, although the apparatus 140 and 142 are severally connected to a secondary channel 150, they are in the state of being unable to communicate with each other because the apparatus 140 and 142 do not have mutual network addresses. The apparatus 140 and the telephone 110 are connected with each other through the peripheral equipment connection unit 130. Consequently, the apparatus 140 and the telephone 110 can mutually exchange information. The same situation is true between the apparatus 142 and the telephone 112.

Next, a method for switching a state in which the telephones 110 and 112 are talking with each other via the primary channel 160 to a state in which the apparatus 140 and the telephone 112 establish the connection between them via the secondary channel 150 is described.

The users A and B are carrying out sound communication with each other using the telephones 110 and 112 through the primary channel 160, namely they are talking over the telephones 110 and 112, at a certain time point.

Then, it is assumed that either user of the two wants to switch the communication to the communication between the apparatus 140 and 142 because the user wants to transmit data having a large, amount such as document data. The user A operates the apparatus 140 to transmit the request to the apparatus 140.

The apparatus 140, which has received the request from the user A, establishes the connection with the apparatus 142 using the communication path via the telephone 110, the primary channel 160 and the telephone 112. Then, the apparatus 140 transmits terminal specifying information specifying the terminal equipment on the transmitting side (the apparatus 140) to the apparatus 142. The terminal specifying information includes, for example, the IP address, the service protocol and the port number of the sending side.

When the apparatus 142 receives the terminal specifying information transmitted via the primary channel 160, the apparatus 142 specifies the terminal (apparatus 140) which should be connected with the apparatus 142 based on the information included in the terminal specifying information. Then, the apparatus 142 establishes the connection with the apparatus 140 using the communication path via the secondary channel 150. In this manner, the apparatus 140 and 142 enter the state capable of performing communicate via the secondary channel 150. After that, the communication between the telephones 110 and 112 via the primary channel 160 is cut off.

However, the case of the connection switching control method including the processing of transmitting terminal specifying information from an information communication terminal on one side to an information communication terminal on the other side via a communication channel used by voice communication terminals has the following problems.

When both the telephones 110 and 112 are cellular phones and the primary channel 160 is a cellular phone network, communication between both of the cellular phones is unstable, and it is easy for mutual connection to be cut off. Consequently, there is the possibility that the connection via the primary channel 160 is cut off before the apparatus 140 and 142 establish the connection via the secondary channel 150. In this case, it is necessary to establish the connection between the telephones 110 and 112 again.

Furthermore, in the case of this method, the terminal specifying information is transmitted to the apparatus 142 via the primary channel 160 at the time of switching the connection. Because the cellular phone network is used as the primary channel 160, communication charges are expensive.

Moreover, in the case of this method, it is impossible to switch the state in which the apparatus 140 and 142 are communicating with each other via the secondary channel 150 to the state in which the cellular phones talk with each other.

### SUMMARY

A storage medium readable by a computer, of the invention, the storage medium storing a connection switching program to perform a function of a first information communication terminal included in an electronic conference system includes the first information communication terminal; a second information communication terminal; a first mobile communication terminal capable of information interchange with the first information communication terminal; a second mobile communication terminal that is capable of information interchange with the second information communication terminal, and has identification information to be held by the first mobile communication terminal; and a storage unit that stores identification information of each of the information communication terminals in associated with identification information of each of the mobile communication terminals; the function includes obtaining the identification information of the second mobile communication terminal from the first mobile communication terminal; obtaining the identification information of the second information communication terminal which corresponds to obtained the identification information of the second mobile communication terminal from the storage unit; and connecting with the second information communication terminal through a communication network, based on the obtained identification information of the second information communication terminal.

### BRIEF DESCRIPTION OF THE DRAWINGS

Embodiments of the present invention will be described in detail based on the following figures, wherein:

FIG. 1 is a configuration diagram of an electronic conference system in an embodiment of the present invention;

FIG. 2 is a table registered in a directory database in the embodiment of the present invention;

FIG. 3 is a flowchart showing the flow of the processing in a communication management unit of a cellular phone in the embodiment of the present invention;

FIG. 4 is a flowchart showing the flow of the connection processing of an electronic conference in the embodiment of the present invention;

FIG. 5 is a flowchart showing the flow of the connection processing of the electronic conference by a first connection method in the embodiment of the present invention;

FIG. 6 is a flowchart showing the flow of the connection processing of the, electronic conference by a second connection method in the embodiment of the present invention;

FIG. 7 is a flowchart showing the flow of the connection processing of the electronic conference by a third connection method in the embodiment of the present invention;

FIG. 8 is a flowchart showing the flow of the processing in an electronic conference terminal in the case of switching the state in which an electronic conference is configured with electronic conference terminals including the electronic conference terminal to the state in which the electronic conference terminals participate in the electronic conference using a cellular phone in another embodiment of the present invention;

FIG. 9 is a flowchart showing the flow of the processing for determining a connection destination in the case of participating in the electronic conference using the cellular phone in the embodiment of the present invention; and

FIG. 10 is a configuration diagram for illustrating a related art connection switching method with information communication terminals and voice communication terminals.

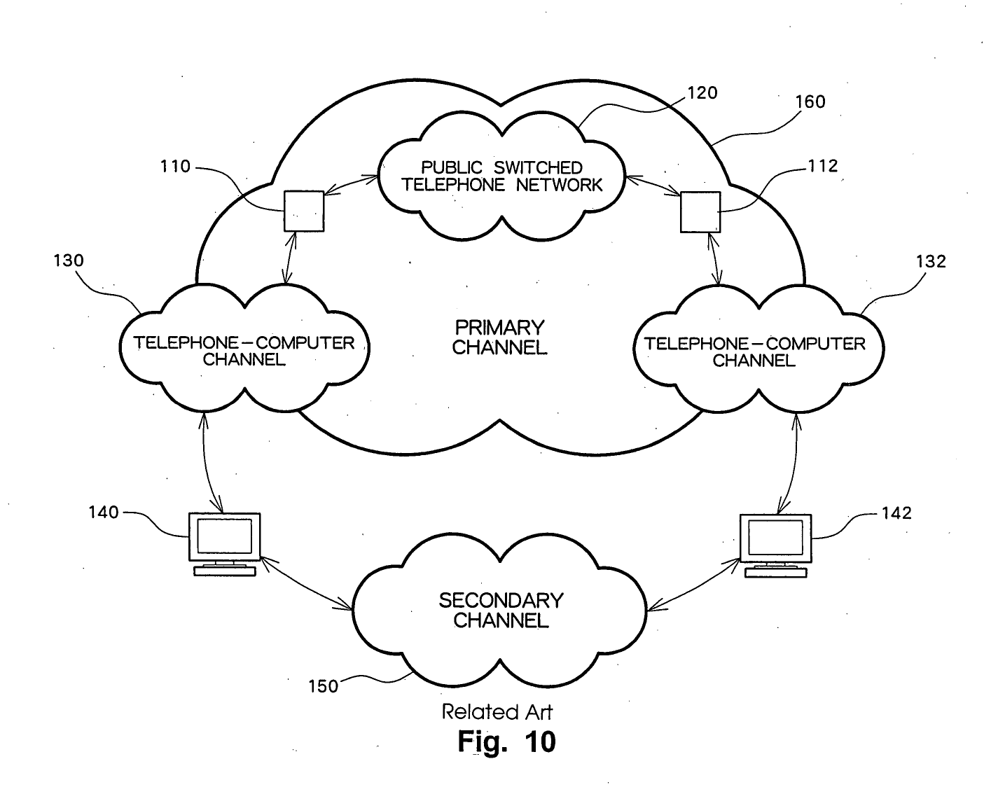

### DETAILED DESCRIPTION

An electronic conference in the present specification means a conference which is held by plural communication terminals that are located at distant places and are connected with each other through communication lines. The conference is met with the plural communication terminals transmitting and receiving information common to the respective communication terminals.

In the present embodiment, the method of participating in an electronic conference to transmit and receive information between communication terminals includes the method of participating in the conference using an information communication terminal such as a computer to transmit and receive image information and sound information, and the method of connecting a voice communication terminal such as a cellular phone to one of the information communication terminals which constitute the electronic conference through a communication line to transmit and receive sound information via the information communication terminal.

### Embodiment 1

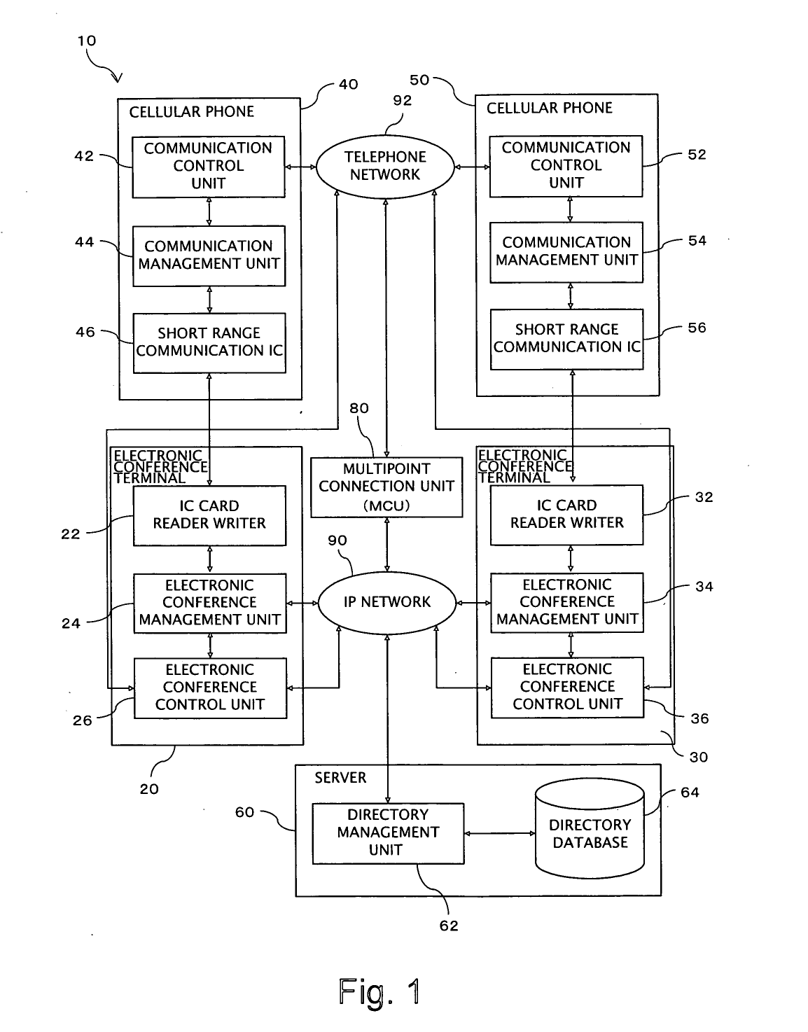

FIG. 1 shows the configuration of the electronic conference system 10 according to the present embodiment 1. The electronic conference system 10 in the present embodiment includes an electronic conference terminal 20, an electronic conference terminal 30, a cellular phone 40, a cellular phone 50, a server 60 and a multipoint connection unit 80.

The electronic conference terminal 20 and the electronic conference terminal 30 are information communication terminals such as computers, and are communication terminals which constitute an electronic conference. The electronic conference terminals 20 and 30 are connectable through an IP network 90. When the electronic conference terminal 20 on one side is connected with the electronic conference terminal 30 on the other side through the IP network 90, the electronic conference terminal 20 specifies the electronic conference terminal 30 by means of identification information (hereinafter referred to as an IP address) such as an IP address to be connected with the electronic conference terminal 30. For the convenience of descriptions, the descriptions are given on the supposition that the electronic conference terminal which tries to be connected is referred to as the first electronic conference terminal 20, and that the electronic conference terminal to be connected to is referred to as the second electronic conference terminal 30. In addition, this discrimination is made simply for the convenience of descriptions, and it is possible to transpose the first electronic conference terminal 20 and the second electronic conference terminal 30. After each of the electronic conference terminals 20 and 30 are connected with each other, the transmissions of image information and sound information become possible at least from the electronic conference terminal 20 on one side to the electronic conference terminal 30 on the other side. Each of the electronic conference terminals 20 and 30 are connected also to a telephone network 92. Consequently, the cellular phone 40 and the like, which will be described later, can be connected with each of the electronic conference terminals 20 and 30 through the telephone network 92. When another communication terminal is connected with each of the electronic conference terminals 20 and 30 through the telephone network 92, the other communication terminal is connected with each of the first and the second electronic conference terminals 20 and 30 by specifying the second electronic conference terminal 30 by means of identification information for a telephone such as a telephone number (hereinafter referred to as a telephone number).

The cellular phone 40 and the cellular phone 50 are mobile communication terminals connectable to the other communication terminals through the telephone network 92. When the cellular phone 40 is connected with the cellular phone 50 through the telephone network 92, the cellular phone 40 specifies the cellular phone 50, which is the connection destination, by means of the telephone number thereof, and the cellular phone 40 is connected with the cellular phone 50. For convenience of descriptions, the descriptions are given on the supposition that the cellular phone which tries to connect is the first cellular phone 40, and that the cellular phone that is the object of the connection is the second cellular phone 50. In addition, this discrimination is made simply for the convenience for a description, and it is possible to transpose the first cellular phone 40 and the second cellular phone 50. The first cellular phone 40 is connectable with the second cellular phone 50, and is connectable with each of the electronic conference terminals 20 and 30 through the telephone network 92. Then, the first cellular phone 40 can carry out information interchange with the electronic conference terminal 30, namely can be connected with the electronic conference. However, the information interchanged by the cellular phone 40 is only sound information.

The multipoint connection unit 80 is an information communication terminal such as a computer, and is a connection intermediately unit used for each of the members constituting the electronic conference. The members constituting an electronic conference in the present embodiment indicate a communication terminal capable of participating in the electronic conference. For example, the members indicate each of the electronic conference terminals 20 and 30, and each of the cellular phones 40 and 50. The multipoint connection unit 80 is connected to each of the electronic conference terminals 20 and 30 through the IP network 90. The multipoint connection unit 80 connects the first electronic conference terminal 20 and the second electronic conference terminal 30 with each other, and each of the electronic conference terminals 20 and 30 are connected with the multipoint connection unit 80. Thereby, the first electronic conference terminal 20 is connected with the second electronic conference terminal 30. In this manner, when each of the electronic conference terminals 20 and 30 are connected with each other using the multipoint connection unit 80, one of the electronic conference terminals 20 and 30 is connected to the other of the electronic conference terminals 20 and 30 via the multipoint connection unit 80. When each of the electronic conference terminals 20 and 30 is connected with the multipoint connection unit 80 through the IP network 90, each of them is connected to the multipoint connection unit 80 by specifying the multipoint connection unit 80 by means of the IP address thereof. When a mobile communication terminal such as the cellular phone 40 is connected with the multipoint connection unit 80 through the telephone network 92, the mobile communication terminal is connected to the multipoint connection unit 80 by specifying the multipoint connection unit 80 by means of the telephone number assigned to the multipoint connection unit 80.

The server 60 is an information communication terminal, and comprises a terminal identification information management unit managing the terminal identification information necessary for the connection with the communication terminals such as each of the electronic conference terminals 20 and 30 and each of the cellular phones 40 and 50. The server 60 is connected with each of the electronic conference terminals 20 and 30 through the IP network 90, and when the server 60 receives an obtainment request of connection information from each of the electronic conference terminals 20 and 30, the server 60 returns the connection information meeting the specified conditions to each of the electronic conference terminals 20 and 30.

Successively, the details of each configuration will be described. In addition, because the second cellular phone 50 has the configuration similar to that of the first cellular phone 40, the description concerning the configuration of the second cellular phone 50 is omitted. Because the second electronic conference terminal 30 similarly has the configuration similar to that of the first electronic conference terminal 20, the description concerning the configuration of the second electronic conference terminal 30 is omitted.

The cellular phone 40 is provided with a communication control unit 42, a communication management unit 44 and a short range communication IC 46.

The communication control unit 42 is a communication control unit for a cellular phone for communicating with another terminal through the telephone network 92. The communication control unit 42 manages the telephone number al of the cellular phone 40, and communication histories such as the telephone numbers which the cellular phone 40 transmitted and received in the past (transmission history and reception history). Moreover, the communication control unit 42 manages the information on the connection state of the cellular phone 40.

The short range communication IC 46 is a storage medium which is built into the cellular phone 40 and which can be read and written. As such an IC, for example, FeliCa (registered trademark) can be cited. The short range communication IC 46 can be read and written from the inside of the communication management unit 44. Moreover, by using the equipment which reads the contents of the short range communication IC 46, reading and writing are able to be carried out from an apparatus different from the cellular phone 40 by utilizing electromagnetic waves. Because of utilizing the electromagnetic waves, the interchange of information can be carried out in the state of being not in contact with the cellular phone 40.

The communication management unit 44 is an operation management unit of the cellular phone 40 for managing the operation of the communication control unit 42 and for carrying out the reading and the writing of information from and to the short range communication IC 46. The communication management unit 44 is started by an operation of a user, and obtains the telephone numbers which the cellular phone 40 transmitted and received in the past (a transmission history and a reception history). Then, the communication management unit 44 writes the telephone number al of the cellular phone 40 and the telephone number b1 of the cellular phone 50 into the short range communication IC 46.

In addition, the functions of each unit of the cellular phone 40 are realized by the cooperative operations of the applications and the hardware resources which are built into the cellular phone 40.

The electronic conference terminal 20 includes an IC card reader writer 22, an electronic conference management unit 24 and an electronic conference control unit 26.

The IC card reader writer 22 is an apparatus for reading and writing information from and to the short range communication IC 46 built into the cellular phone 40 in a non-contact sate. As such a read write apparatus for an IC card, for example, PaSoRi (registered trademark) can be cited. When the IC card reader writer 22 is standing by in the state of read write request, and when the user holds up the cellular phone 40 near the IC card reader writer 22, the IC card reader writer 22 reads the telephone number a1 of the cellular phone 40 and the telephone number b1 of the cellular phone 50 from the short range communication IC 46. In this manner, the IC card reader writer 22 receives the information held by the cellular phone 40, namely the telephone number a1 of the cellular phone 40 and the telephone number b1 of the cellular phone 50, by reading the information held in the short range communication IC 46. On the other hand, when the IC card reader writer 22 is standing by in the write request state, and when the user holds up the cellular phone 40 near the IC card reader writer 22, the IC card reader writer 22 writes a telephone number into the short range communication IC 46. The details of the telephone number will be described later.

The electronic conference management unit 24 is a management unit of the connection information for being connected with the communication terminals such as the electronic conference terminal 30, the cellular phone 50 and the multipoint connection unit 80. The electronic conference management unit 24 receives the telephone number al of the cellular phone 40 and the telephone number b1 of the cellular phone 50 from the IC card reader writer 22. The electronic conference management unit 24 specifies the telephone number b1 of the cellular phone 50, and obtains the IP address which is the terminal identification information of a connection destination from the server 60. In this manner, the electronic conference management unit 24 has a role as a connection destination terminal identification information management unit.

The electronic conference control unit 26 is a connection unit for enabling the electronic conference terminal 20 to be connected with the other communication terminals. The electronic conference control unit 26 is connected with the other electronic conference terminals through the IP network 90. Moreover, the electronic conference control unit 26 is connected to each of the cellular phones 40 and 50 through the telephone network 92. The electronic conference control unit 26 has a role as a communication terminal connection unit for being connected with the other communication terminals.

In addition, the functions of each unit of the electronic conference terminal 20 are realized by the cooperative operation of the applications and the hardware resources that are built into the electronic conference terminal 20.

The server 60 includes a directory management unit 62 and a directory database 64.

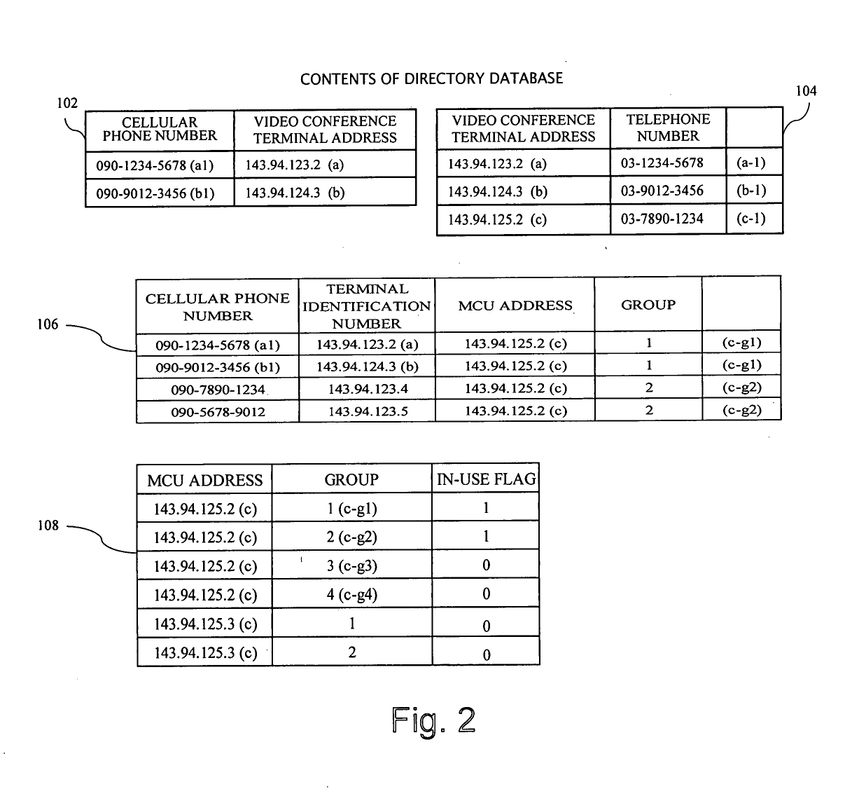

The directory database 64 saves the information for being connected with each of the electronic conference terminals 20 and 30, each of the cellular phones 40 and 50, and the multipoint connection unit 80. Tables registered in the directory database 64 are shown in FIG. 2. The directory database 64 is equipped with a cellular phone information management table 102, an electronic conference terminal information management table 104, a multipoint connection management table 106 and a multipoint connection group management table 108.

The IP address of each of the electronic conference terminals 20 and 30 is associated with the telephone number of each of the cellular phones 40 and 50 to be registered in the cellular phone information management table 102. The cellular phone information management table 102 is used in the case of retrieving the electronic conference terminal corresponding to the telephone number of a cellular phone from the telephone number, or in the case of retrieving the telephone number of the cellular phone corresponding to the IP address of an electronic conference terminal from the IP address.

The telephone number of each of the electronic conference terminals 20 and 30 and the multipoint connection unit 80 is associated with the IP address of each of them to be registered in the electronic conference terminal information management table 104. The electronic conference terminal information management table 104 is used in the case of retrieving the telephone number corresponding to the IP address of each of the electronic conference terminals 20 and 30 and the multipoint connection unit 80. In addition, the IP address and the telephone number of each of the electronic conference terminals 20 and 30 and the multipoint connection unit 80 have already been determined at the time of building the system. Consequently, the IP addresses and the telephone numbers have been previously registered in the electronic conference terminal information management table 104.

The IP address of each of the electronic conference terminals 20 and 30, the IP address of the multipoint connection unit 80 (hereinafter referred to as an MCU address), and the group number are associated with the telephone number of each of the cellular phones 40 and 50 to be registered in the multipoint connection management table 106. When there are plural IP addresses corresponding to the same MCU address and the same group number, each of the electronic conference terminals specified by the IP address are meant to be connected with each other through the multipoint connection unit 80. Moreover, the cellular phones specified by the cellular phone numbers corresponding to the same MCU address and the same group number are able to participate in an electronic conference through the multipoint connection unit 80. That is, the electronic conference terminals and the cellular phones that are associated with the same MCU address and the same group number are the constituent members of one electronic conference. In order to connect each of the electronic conference terminals 20 and 30 with each other through the multipoint connection unit 80, it is necessary for the IP address of each of the electronic conference terminals 20 and 30 to correspond to the same MCU address and the same group number in the multipoint connection management table 106. In this manner, the multipoint connection management table 106 is used in the case where each of the electronic conference terminals 20 and 30 is connected with each other through a multipoint connection unit 80.

It is possible to set plural MCU addresses in the multipoint connection management table 106. By setting plural MCU addresses, it is also possible to provide plural multipoint connection units in one electronic conference system. Moreover, it is possible to set plural groups to the same MCU address. By setting plural groups, it is possible to form plural electronic conferences corresponding to the respective groups to one multipoint connection unit.

In-use flags indicating whether MCU addresses and group numbers are in use or not are associated with the respective MCU addresses and the respective group numbers to be registered in the multipoint connection group management table 108.

When an MCU address and a group are registered in the multipoint connection management table 106, an MCU address and a group which correspond to an in-use flag being 0 (indicating being not in use) are retrieved from the multipoint connection group management table 108, and the retrieved MCU address and the retrieved group that correspond to the in-use flag being 0 are registered in the multipoint connection management table 106. When an MCU address and a group are registered in the multipoint connection management table 106, the in-use flag corresponding to the MCU address and the group is updated to be 1 (indicating being in use) in the multipoint connection group management table 108. Conversely, when an MCU address and a group are deleted from the multipoint connection management table 106, the in-use flag corresponding to the MCU address and the group is updated to be 0 in the multipoint connection group management table 108. In the case where a group being not in use is retrieved when information is registered in the multipoint connection management table 106, the multipoint connection group management table 108 is used.

In addition, the MCU addresses have been previously registered in the multipoint connection group management table 108. Moreover, the group numbers which can be used by the multipoint connection unit 80 have also been previously registered in the multipoint connection group management table 108.

In this manner, the directory database 64 has a function as a terminal identification information storage unit.

The directory management unit 62 operates the directory database 64 to manage the terminal identification information specifying the terminals of each of the electronic conference terminals 20 and 30, each of the cellular phones 40 and 50, and the multipoint connection unit 80. In response to a request from each of the electronic conference terminals 20 and 30, the directory management unit 62 retrieves the information from the directory database 64 to reply the retrieval result, or updates (including addition and deletion) the information on the directory database 64. In this manner, the directory management unit 62 has a function as the terminal identification information management unit managing the directory database 64.

In addition, the function of the directory management unit 62 is realized by the cooperative operation of the applications and hardware resources that are built in the server 60.

Next, a concrete description is given for the switching processing of connections from the state in which the users A and B are talking over the cellular phones 40 and 50, which are connected with each other, to the state in which the users A and B hold an electronic conference using the electronic conference terminals 20 and 30, respectively, which are connected with each other, in the electronic conference system 10 in the present embodiment. In addition, it is assumed that the user of the cellular phone 40 is the user A, and that the user of the cellular phone 50 is the user B.

Such a situation occurs, for example, in the case where the users A and B begin an electronic conference using the electronic conference terminals 20 and 30, respectively, for exchanging information including images from the state in which they are talking using mutual cellular phones, i.e. the state in which they are exchanging sound information.

The user A operates the cellular phone 40 to instruct the communication management unit 44 to participate in an electronic conference from the electronic conference terminal 20. As a result of the operation, the communication management unit 44 starts the processing for shifting to the electronic conference from the state of talking over the cellular phones 40 and 50. By a similar procedure, the cellular phone 50 also starts the processing for shifting to the electronic conference from the state of talking over the cellular phones 40 and 50. Moreover, the user A operates the electronic conference terminal 20 to instruct the electronic conference management unit 24 to start the electronic conference. As a result of the operation, the electronic conference management unit 24 starts the processing for starting the electronic conference. In addition, the electronic conference terminal 30 also starts the processing for starting the electronic conference with a similar procedure.

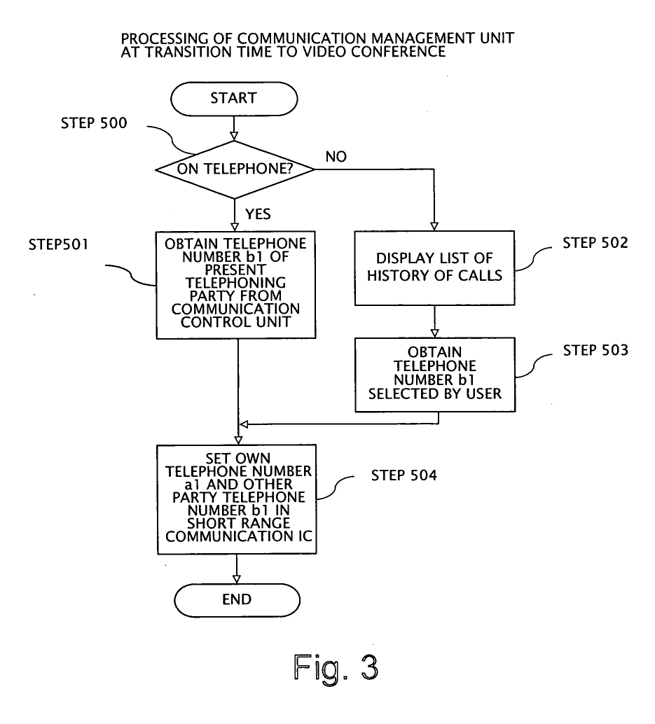

First, the processing in the cellular phone 40 is described by reference to FIG. 3. FIG. 3 is a flowchart showing the processing of writing the information necessary for each of the cellular phones 40 and 50 into each of the short range communication IC's 46 and 56.

When the communication management unit 44 has received the instruction of the user A mentioned above, the communication management unit 44 inquires of the talking state of the cellular phone 40 from the communication control unit 42. The communication control unit 42 ascertains the communication state of the cellular phone 40, and returns a response informing whether the cellular phone 40 is talking or not to the communication management unit 44 (step 500).

When the communication management unit 44 receives a response informing that the cellular phone 40 is now talking from the communication control unit 42, the communication management unit 44 requests the telephone number of the cellular phone 50 that is talking with the cellular phone 50 from the communication control unit 42. The communication control unit 42 receives the request, and returns the telephone number b1 to the communication management unit 44. The communication management unit 44 receives the telephone number b1 as the telephone number of the cellular phone 50 (step 501).

On the other hand, when the communication management unit 44 receives a response informing that the cellular phone 40 is not talking from the communication control unit 42, the communication management unit 44 requests the transmission history and the reception history of the cellular phone 50 of the communication control unit 42. When the communication control unit 42 receives the request, the communication control unit 42 obtains the information on the transmission history and the reception history from the inside of the cellular phone 40, and returns the information on the transmission history and the reception history to the communication management unit 44. The communication management unit 44 displays the list of the telephone numbers included in the received information on the transmission history and the reception history on the display screen of the cellular phone 40 (step 502).

The user A operates the cellular phone 40 to select the telephone number b1 of the cellular phone 50, which is the telephone number of the cellular phone of the user B, from the displayed telephone numbers. The communication management unit 44 receives the telephone number b1 of the cellular phone 50 (Step 503). In this manner, the communication management unit 44 obtains the telephone number b1 of the cellular phone 50, which is the connection destination, as a result of the processing of the steps 501-503.

The communication management unit 44 writes the telephone numbers a1 and b1 of the cellular phones 40 and 50, respectively, into the short range communication IC 46. Also in the cellular phone 50, a communication management unit 54 similarly writes the telephone number b1 of the cellular phone 50, which is the own terminal, and the telephone number a1 of the cellular phone 40, which is the terminal of the connection destination, into a short range communication IC 56 (step 504).

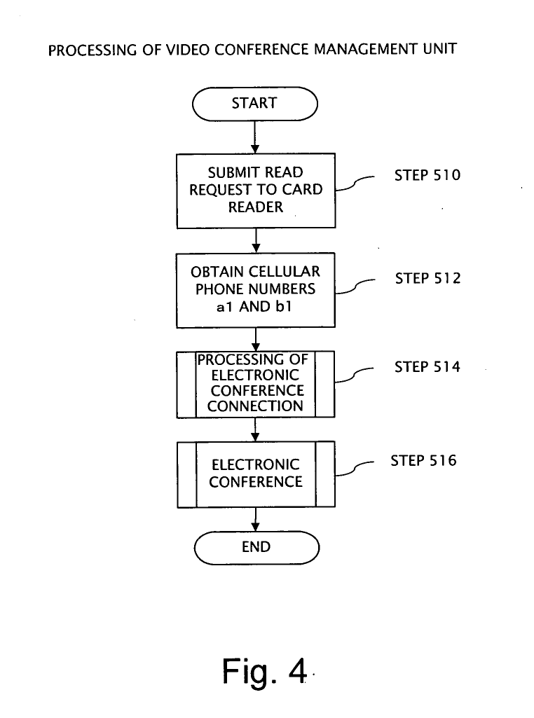

Next, the processing for the users A and B to start an electronic conference using each of the electronic conference terminals 20 and 30, respectively, is described by reference to FIG. 4. FIG. 4 is a flowchart showing the flow of the processing for the connection of each of the electronic conference terminals 20 and 30.

As a result of the operation of the electronic conference terminal 20 by the user A, a start notice of an electronic conference is transmitted to the electronic conference management unit 24. When the electronic conference management unit 24 receives the start notice of an electronic conference, the electronic conference management unit 24 transmits a read request notice to the IC card reader writer 22 (step 510).

When the IC card reader writer 22 receives the read request notice, the IC card reader writer 22 stands by in the state of a read request. When the user A brings the cellular phone 40 close to the IC card reader writer 22, and when the IC card reader writer 22 thereby enters the state capable of reading the information on the short range communication IC 46, the IC card reader writer 22 reads the telephone numbers a1 and b1 of each of the cellular phones 40 and 50, respectively, from the short range communication IC 46, and transmits the read telephone numbers a1 and b1 to the electronic conference management unit 24. The electronic conference management unit 24 receives the transmitted telephone numbers a1 and b1. Similarly as for the electronic conference terminal 30, an electronic conference management unit 34 receives the telephone numbers a1 and b1 in response to the read operation of the user B. In this manner, the IC card reader writer 22 has a role as a mobile communication terminal identification information obtainment unit of the cellular phone 50 (step 512).

Then, each of the electronic conference terminals 20 and 30 are connected with each other, and an electronic conference is formed (step 514).

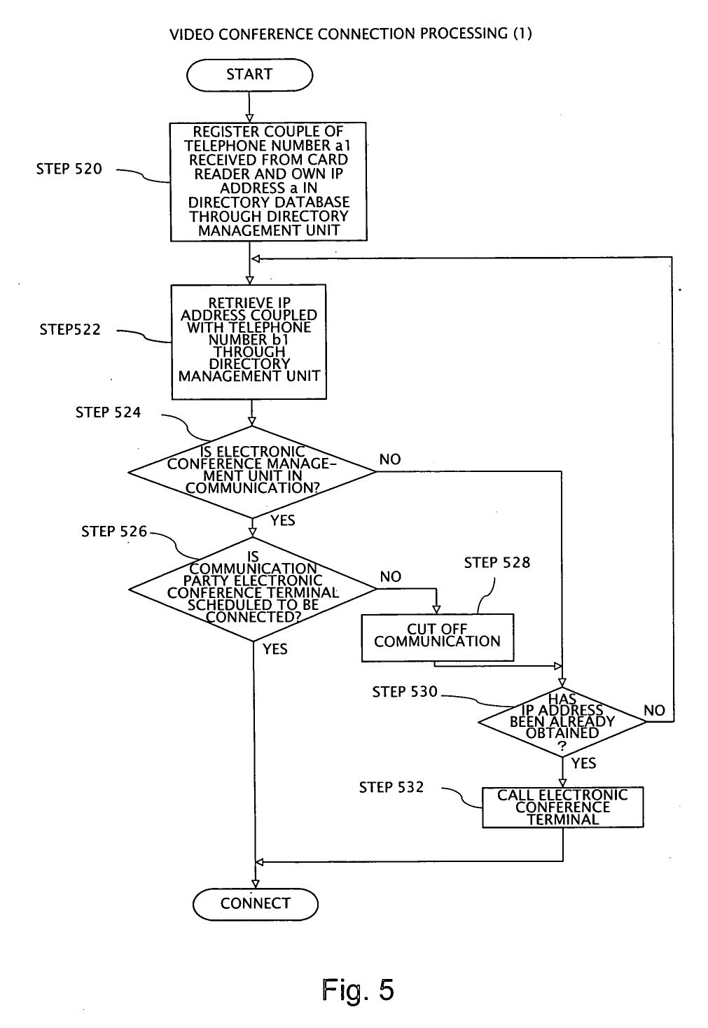

In the present embodiment, there are three methods of connecting each of the electronic conference management units 24 and 34. These methods are described based on the flowcharts of FIGS. 5-7. In addition, the connection method selected for the electronic conference system 10 is statically set, and each of the electronic conference terminals 20 and 30 is supposed to be able to obtain the set contents at any time.

First, a first connection method is described based on FIG. 5. FIG. 5 is a flowchart related to the method of each of the electronic conference terminals 20 and 30 for trying connection to the conference terminal of the other party regardless of connection order.

When the electronic conference management unit 24 receives the telephone numbers a1 and b1 from the IC card reader writer 22, through the IP network 90 the electronic conference management unit 24 notifies the directory management unit 62 to register the telephone number a1 of the cellular phone 40 and the IP address a of the electronic conference terminal 20 into the directory database 64. When the directory management unit 62 receives the notification, the directory management unit 62 registers the telephone number a1 and the IP address a into the cellular phone information management table 102 of the directory data base 64 in the state in which the telephone number a1 and the IP address a are associated with each other (step 520).

Successively, the electronic conference management unit 24 transmits an obtainment request notice of the IP address associated with the telephone number b1 of the cellular phone 50 to the directory management unit 62. On the other hand, the electronic conference management unit 34 has also transmitted an obtainment request notice of the IP address associated with the telephone number a1 of the cellular phone 40 to the directory management unit 62. It is impossible to know in advance which processing of the processing executed by the electronic conference management unit 24 and the processing executed by the electronic conference management unit 34 is executed first. For the convenience of description, the description is given here on the supposition that the processing executed by the electronic conference management unit 24 is executed prior to the processing executed by the electronic conference management unit 34.

When the directory management unit 62 receives the obtainment request notice from the electronic conference management unit 24, the directory management unit 62 retrieves the IP address corresponding to the telephone number b1 of the cellular phone 50 from the cellular phone information management table 102. Because the execution of the connection processing of the electronic conference by the electronic conference terminal 20 has preceded the execution of that by the electric conference terminal 30, the telephone number b1 of the cellular phone 50 is not registered in the cellular phone information management table 102. Consequently, the number of the retrieved IP addresses is zero (step 522).

After the electronic conference management unit 24 has received the retrieval result from the directory management unit 62, the electronic conference management 24 inquires to the electronic conference control unit 26 about whether the electronic conference terminal 20 is being connected or not. The electronic conference control unit 26 ascertains the connection state, and returns the result of the ascertainment to the electronic conference management unit 24. In addition, because the electronic conference terminal 30 is not connected to the electronic conference terminal 20 at this time point, the electronic conference terminal 20 will not be talking in an ordinal case. However, the case where the electronic conference terminal 20 is connected with an electronic conference terminal other than the electronic conference terminal 30 to be talking with the connected electronic conference terminal rarely exists (Step 524).

When the connection state of the electronic conference terminal 20 is not talking, the electronic conference management unit 24 judges whether the electronic conference management unit 24 has obtained any IP addresses or not. Because the number of the IP addresses retrieved at the step 522 is zero, the electronic conference management unit 24 has not obtained any IP addresses at this time point. In that case, the processing returns to the processing at the step 522 again (step 530). In this manner, the electronic conference management unit 24 repeats the connection processing until the electronic conference terminal 20 is connected with the electronic conference terminal 30.

The connection processing for the electronic conference is executed by the electronic conference terminal 30 later than that executed by the electronic conference terminal 20. This processing will now be described.

When the electronic conference management unit 34 receives the telephone numbers a1 and b1 from an IC card reader writer 32, the electronic conference management unit 34 notifies the directory management unit 62 through the IP network 90 to register the telephone umber b1 of the cellular phone 50 and the IP address b of the electronic conference terminal 30. When the directory management unit 62 receives the notice, the directory management unit 62 associates the telephone number b1 and the IP address b with each other to register the associated telephone number b1 and the IP address b into the cellular phone information management table 102 of the directory database 64 (step 520).

Successively, the electronic conference management unit 34 notifies the directory management unit 62 to obtain the IP address corresponding to the telephone number a1 of the cellular phone 40. When the directory management unit 62 receives the notice, the directory management unit 62 retrieves the IP address corresponding to the telephone number a1 from the cellular phone information management table 102. Before the processing is executed, the processing of the step 520 has already been executed, and the telephone number a1 of the cellular phone 40 and the IP address of the first electronic conference terminal 20 have already been registered in the cellular phone information management table 102. Consequently, the directory management unit 62 returns the IP address a corresponding to the telephone number a1 from the cellular phone information management table 102 to the electronic conference management unit 34 (step 522).

After the electronic conference management unit 34 has received the IP address a from the directory management unit 62, the electronic conference management unit 34 inquires of an electronic conference control unit 36 about whether the electronic conference terminal 30 is communicating or not. In addition, it is assumed here that the electronic conference management unit 34 has received a result that the electric conference terminal 30 is not communicating (step 524).

When the electronic conference terminal 30 is not communicating, the electronic conference management unit 34 ascertains whether it has obtained the IP address or not. At the step 522, the electronic conference management unit 34 has obtained the IP address a of the electronic conference terminal 20. Accordingly, the processing is moved to the next processing (step 530).

The electronic conference management unit 34 notifies the electronic conference control unit 36 to specify the obtained IP address a to be connected with the electronic conference terminal 20. When the electronic conference control unit 36 receives the notice, the electronic conference control unit 36 specifies the IP address a, and is connected with the electronic conference terminal 20 through the IP network 90 (step 532).

The processing after the time point when the processing in the electronic conference terminal 20 has returned to the processing at the step 522 again at the step 530 is described.

The electronic conference management unit 24 again notifies the directory management unit 62 to obtain the IP address corresponding to the telephone number b1. At this time point, the telephone number b1 of the second cellular phone 50 and the IP address b of the second electronic conference terminal 30 have been registered in the cellular phone information management table 102. Accordingly, the electronic conference management unit 24 obtains the IP address b of the second electronic conference terminal 30 (step 522).

The electronic conference management unit 24 inquires of the electronic conference control unit 26 about whether the electronic conference terminal 20 is in communication or not. In addition, it is assumed here that the electronic conference management unit 34 has received a result that the electronic conference terminal 30 is not in communication (Step 524).

When the electronic conference terminal 20 is not communicating, the electronic conference management unit 24 ascertains whether it has obtained any IP addresses or not. At the step 522, the electronic conference management unit 24 has obtained the IP address b of the electronic conference terminal 30. Accordingly, the processing is moved to the next processing (Step 530).

The electronic conference management unit 24 notifies the electronic conference control unit 26 to specify the obtained IP address b to be connected with the electronic conference terminal 30. When the electronic conference control unit 26 receives the notification, the electronic conference control unit 26 specifies the IP address b, and is connected with the electronic conference terminal 30 through the IP network 90 (step 532).

When the electronic conference management unit 24 has ascertained in the processing at the step 524 that the electronic conference terminal 20 is in communication, the electronic conference management unit 24 compares the IP address of the electronic conference terminal in communication with the IP address obtained as a result of the processing at the step 522. In this case, the IP address of the electronic conference terminal in communication is the IP address b, and the IP address obtained by the processing at the step 522 is also the IP address b. Then, both the IP addresses agree with each other. Accordingly, the electronic conference management unit 24 judges that the electronic conference terminal connected is the electronic conference terminal that had been planned to be connected, and the electronic conference management unit 24 ends the connection processing (step 526).

When the electronic conference terminal 20 is connected to the electronic conference terminal 30, the electronic conference management unit 24 ends the connection processing without executing the processing at the step 530. Consequently, the electronic conference management unit 24 exits from the repetition processing of the connection processing from the step 522 to the step 530. In addition, when the IP address of the electronic conference terminal under connection differs from the IP address obtained by the processing at the step 522 in the judgment at the step 526, the electronic conference management unit 24 notifies the electronic conference control unit 26 to cut off the communication. When the electronic conference control unit 26 receives the notification, the electronic conference control unit 26 cuts off the communication (step 528). After that, the processing is moved to the processing at the step 530, and the following processing is executed. With that, the description pertaining to the first connection method is ended.

In addition, although the description has been given, for the convenience of description, on the assumption that the processing executed by the electronic conference management unit 24 is executed before the execution of the processing executed by the electronic conference management unit 34, the electronic conference terminal 20 and the electronic conference terminal 30 are connected with each other even if the order is reverse.

According to the connection method, because each of the electronic conference terminals 20 and 30 mutually executes the connection processing to the electronic conference terminal of the other party, both the terminals 20 and 30 are immediately connected as soon as both the terminals 20 and 30 become connectable.

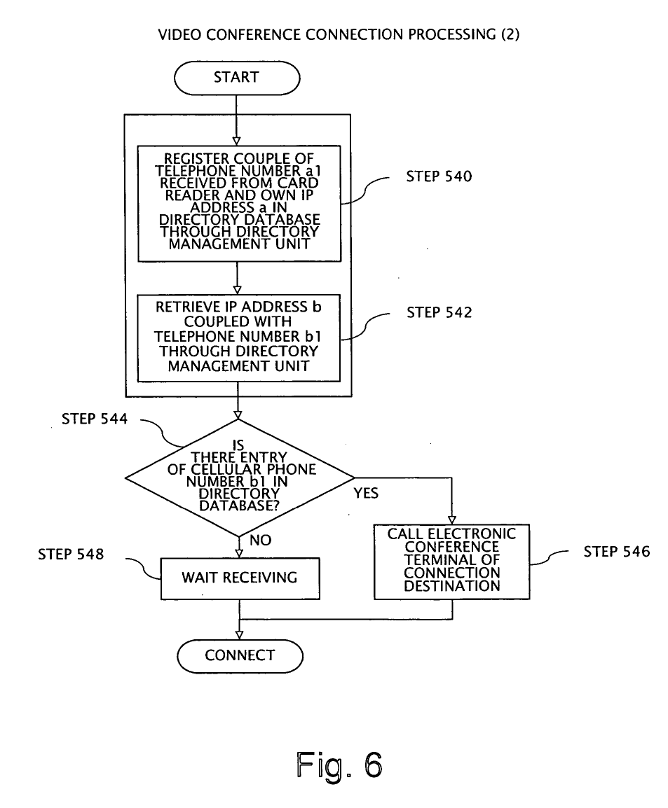

Next, the second connection method is described based on FIG. 6. FIG. 6 is a flowchart related to a connection method by which the electronic conference terminal that has registered information into the directory database 64 first between each of the electronic conference terminals 20 and 30 stands by and the electronic conference terminal that has registered information into the directory database 64 later is connected with the first electronic conference terminal that is standing by.

When the electronic conference management unit 24 receives the telephone numbers a1 and b1 from the IC card reader writer 22, the electronic conference management unit 24 transmits the notice of registration of the IP addresses of the cellular phone 40 and the electronic conference terminal to the directory management unit 62. On the other hand, the electronic conference management unit 34 also transmits the notice of registration of the IP address associated with the telephone number a1 of the cellular phone 40 to the directory management unit 62. It is impossible to previously know which processing between the processing executed by the electronic conference management unit 24 and the processing executed by the electronic conference management unit 34 is executed first. Accordingly, for the convenience of description, the description is given here on the assumption that the processing executed by the electronic conference management unit 24 is executed first. When the directory management unit 62 receives the notice of registration from the electronic conference management unit 24, the directory management unit 62 locks the cellular phone information management table 102 in case the cellular phone information management table 102 should be updated in response to the notice from the electronic conference terminal 30. On that basis, the directory management unit 62 associates the telephone number a1 of the cellular phone 40 with the IP address a of the electronic conference terminal 20 to register the associated telephone number a1 and the IP address a into the cellular phone information management table 102 of the directory database 64 (step 540).

Next, the electronic conference management unit 24 transmits an obtainment notice of the IP address relevant to the telephone number b1 to the directory management unit 62. The directory management unit 62 ascertains that the notice is the obtainment notice transmitted from the electronic conference terminal 20, and retrieves the IP address corresponding to the telephone number b1 from the cellular phone information management table 102 to return the retrieval result of the IP address to the electronic conference management unit 24. After that, the directory management unit 62 releases the locking of the cellular phone information management table 102. The execution of the connection processing to an electronic conference by the electronic conference terminal 20 precedes the execution of the connection processing to the electronic conference by the electronic conference terminal 30. Consequently, the information of the cellular phone 50 has not been registered in the cellular phone information management table 102. As a result, the number of the retrieved IP addresses is zero (step 542).

The items of processing at the steps 540 and 542 are executed by the directory management unit 62 as the items of atomic processing on a database. That is, it is ensured that the contents of the cellular phone information management table 102 are not rewritten by the electronic conference terminal 30 during a period from the start of the processing at the step 540 to the end of the processing at the step 542. Moreover, when abnormalities have occurred before the end of the processing at the step 542, it is ensured that the state of the processing is returned to the state before the processing at the step 540.

In the case where the IP address b of the electronic conference terminal 30 is registered in the cellular phone information management table 102 at the time point when the processing at the step 542 has ended, it is shown that the electronic conference terminal 30 has already started connection processing for organizing an electronic conference. In the case where the IP address b is not registered in the cellular phone information management table 102 at the time point, it is shown that the electronic conference terminal 30 has not executed the connection processing for organizing any electronic conferences yet.

After the processing of the step 542, the electronic conference management unit 24 receives the retrieval result from the directory management unit 62, and ascertains whether there are any IP addresses (step 544).

Because the retrieval number of the IP addresses is zero from the processing at the step 542, the electronic conference management unit 24 does not obtain any IP addresses at this time point. In this case, the electronic conference management unit 24 stands by until it is connected from the electronic conference terminal 30. In this manner, the electronic conference management unit 24 waits to be connected from other terminals (step 548).

The connection processing of an electronic conference is executed by the electronic conference terminal 30 later than the processing of the electronic conference terminal 20. The processing of the electronic conference terminal 30 will now be described.

When the electronic conference management unit 34 receives the telephone numbers a1 and b1 from the IC card reader writer 32, the electronic conference management unit 34 notifies the directory management unit 62 to register the telephone number b1 and the IP address of the electronic conference terminal 34. The directory management unit 62 receives the notification. However, because the cellular phone information management table 102 is locked by the processing at the steps 540-542 that is generated by the processing of the electronic conference management unit 24, the directory management unit 62 cannot update the cellular phone information management table 102. Accordingly, the directory management unit 62 stands by until the locking of the cellular phone information management table 102 is released.

When the locking is released, the directory management unit 62 locks the cellular phone information management table 102 in case the cellular phone information management table 102 should be updated. On that basis, the directory management unit 62 associates the telephone number b1 of the cellular phone 50 with the IP address b of the electronic conference terminal 30, and registers the associated telephone number b1 and the IP address b into the cellular phone information management table 102 of the directory database 64 (step 540).

Next, the electronic conference management unit 34 notifies the directory management unit 62 to obtain the IP address pertaining to the telephone number a1 of the cellular phone 40. The directory management unit 62 ascertains that the notification is the notification transmitted from the electronic conference terminal 30, and retrieves the IP address corresponding to the telephone number a1 from the cellular phone information management table 102. As a result of the processing at the step 540, the telephone number a1 and the IP address a have already been registered in the cellular phone information management table 102. Accordingly, the directory management unit 62 obtains the IP address a corresponding to the telephone number a1, and returns the obtained IP address a to the electronic conference management unit 34. After that, the directory management unit 62 releases the locking of the cellular phone information management table 102 (step 542).

The electronic conference management unit 34 receives the retrieval result from the directory management unit 62, and ascertains whether there are any IP addresses or not (step 544).

As a result of the processing at the step 542, the electronic conference management unit 34 has already obtained the IP address a. The electronic conference management unit 34 specifies the IP address a to notify the electronic conference control unit 36 to be connected with the electronic conference terminal 20. When the conference control unit 36 receives the notification, the electronic conference control unit 36 specifies the electronic conference terminal 20 to be the connection destination based on the IP address a to be connected with the electronic conference terminal 20 (step 546). As a result of the processing, the electronic conference terminal 20 is connected to the second electronic conference terminal 30. With that, the description pertaining to the second connection method is ended.

In addition, although the description has been given, for the convenience of the description, on the assumption that the processing executed by the electronic conference management unit 24 is executed before the processing executed by the electronic conference management unit 34, the electronic conference terminals 20 and 30 are connected with each other even if the processing order is reverse.

According to the connection method, as soon as both of the electronic conference terminals 20 and 30 become connectable, the electronic conference terminals 20 and 30 are immediately connected with each other, and the electronic conference terminal 20, which has previously executed the connection processing, can be prevented from executing pointless connection processing until the electronic conference terminal 30, which executes the connection processing later, is connected.

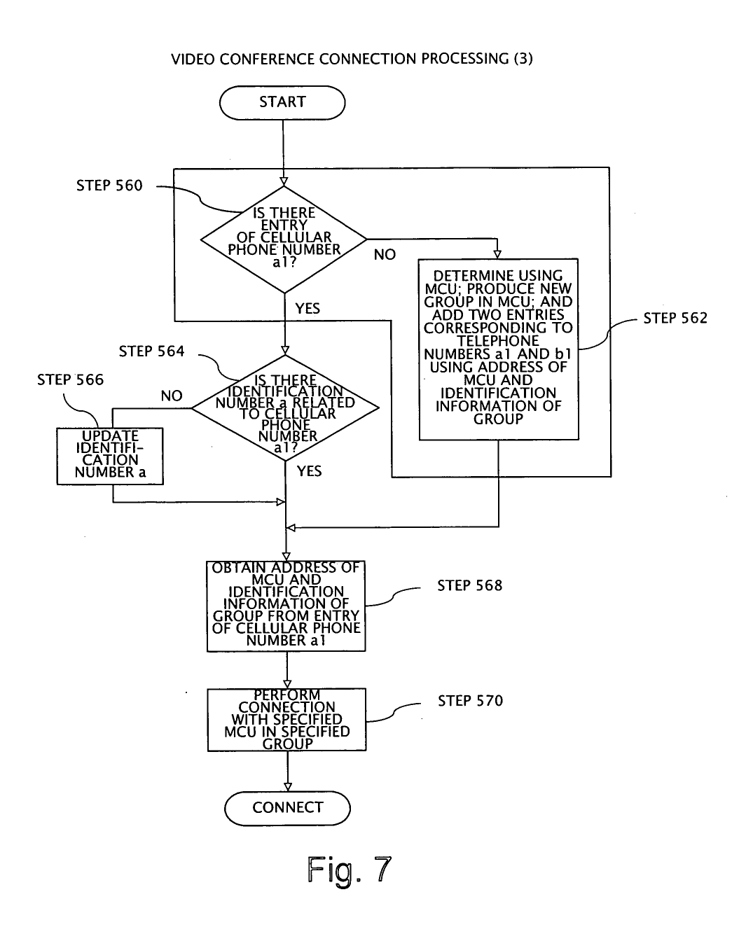

Next, the third connection method is described based on FIG. 7. FIG. 7 is a flowchart pertaining to the connection method in the case of using the multipoint connection unit 80. Although the two methods mentioned above are methods by which an electronic conference terminal on one side is directly connected with an electronic conference terminal on the other side, the third connection method is a method by which each of the electronic conference terminals 20 and 30 are connected with each other via the multipoint connection unit 80.

When the electronic conference management unit 24 receives the telephone numbers a1 and b1 from the IC card reader writer 22, the electronic conference management unit 24 transmits an obtainment request notice of the information corresponding to the telephone number a1 of the cellular phone 40 to the directory management unit 62 through the IP network 90. On the other hand, the electronic conference management unit 34 also transmits an obtainment request notice of the information corresponding to the telephone number a1 of the cellular phone 40 to the directory management unit 62. It is impossible to previously know which processing of the processing executed by the electronic conference management unit 24 and the processing executed by the electronic conference management unit 34 is executed first. For the convenience of description, here, the description is given on the assumption that the electronic conference management unit 24 first executes the processing with the electronic conference management unit 34.

When the directory management unit 62 receives the obtainment request notice from the electronic conference management unit 24, the directory management unit 62 locks the multipoint connection management table 106 in case the multipoint connection management table 106 should be updated by the electronic conference terminal 30. On that basis, the directory management unit 62 retrieves the information corresponding to the telephone number a1 of the cellular phone 40 from the multipoint connection management table 106, and returns the retrieval result to the electronic conference management unit 24 (step 560).

Because the electronic conference terminal 20 has executed the connection processing of the electronic conference before the electronic conference terminal 30, the telephone number a1 of the cellular phone 40 is not registered in the multipoint connection management table 106.

The directory management unit 62 retrieves a group satisfying the conditions that the IP address thereof is an MCU address c, which is the IP address of the multipoint connection unit 80, and the in-use flag thereof is zero (not in use) from the multipoint connection group management table 108. It is assumed that a group c-g1 has been obtained as a result. The directory management unit 62 sets the in-use flag corresponding to the MCU address c and the group c-g1 to 1 (used) to the multipoint connection group management table 108.

The directory management unit 62 registers the telephone number a1 of the cellular phone 40, the IP address a of the first electronic conference terminal 20, the MCU address c and the group c-g1 into the multipoint connection management table 106. Moreover, the directory management unit 62 registers the telephone number b1 of the cellular phone 50, the MCU address c and the group c-g1. However, a dummy IP address is set as the IP address corresponding to the telephone number b1 of the cellular phone 50. This is because the electronic conference terminal 20 cannot specify the IP address corresponding to the telephone number b1 of the cellular phone 50. In addition, the dummy IP address indicates the IP address which does not have any meaningful information for identifying a terminal, although it has the format of the IP address. In this manner, the electronic conference terminal 20, which has been previously connected with the multipoint connection unit 80, registers the telephone number b1 of the cellular phone 50 (the terminal of the other party of the connection) into the multipoint connection management table 106 together with the telephone number a1 of the cellular phone 40 (its own terminal) using the same identifier (MCU address c, group c-g1). After that, the directory management unit 62 releases the locking of the multipoint connection management table 106 (step 562).

The directory management unit 62 returns the MCU address c corresponding to the telephone number a1 to the electronic conference management unit 24 (step 568).

When the electronic conference management unit 24 receives the MCU address c, the electronic conference management unit 24 specifies the obtained MCU address c to the electronic conference control unit 26, and notifies the electronic conference control unit 26 to be connected with the multipoint connection unit 80. When the electronic conference control unit 36 receives, the notification, the electronic conference control unit 36 is connected with the multipoint connection unit 80 based on the MCU address c (step 570).

The connection processing of the electronic conference terminal 30 to the electronic conference is performed later than that of the electronic conference terminal 20, which has previously performed processing. This processing will now be described.

The electronic conference management unit 34 notifies the directory management unit 62 to obtain the information corresponding to the telephone number b1 of the cellular phone 50. However, the multipoint connection management table 106 is locked as a result of the processing at the steps 560 and 562. In this case, the directory management unit 62 stands by. When the locking of the multipoint connection management table 106 is released, the directory management unit 62 retrieves the information of the telephone number b1 of the cellular phone 50 from the multipoint connection management table 106. At this time point, the processing at the step 562 has already been executed, and the dummy IP address is registered in the multipoint connection management table 106 as the telephone number b1. As a result, the directory management unit 62 returns the dummy IP address to the electronic conference management unit 34. The electronic conference management unit 34 receives the retrieval result (step 570).

In the case where the electronic conference management unit 34 has one retrieval result, the electronic conference management unit 34 ascertains whether the IP address included in the retrieval result is the dummy IP address or not (step 564). In this case, because the electronic conference management unit 34 has obtained the dummy IP address at the step 570, the electronic conference management unit 34 makes the directory management unit 62 update the information on the IP address corresponding to the telephone number b1 to the IP address b. On the other hand, when the IP address obtained by the electronic conference management unit 34 is not the dummy IP address, the processing transfers to the next processing (step 566).

After that, the electronic conference management unit 34 notifies the directory management unit 62 to obtain the information corresponding to the telephone number b1 of the cellular phone 50. When the directory management unit 62 receives the notification, the directory management unit 62 obtains the MCU address c and the group c-g1, both corresponding to the telephone number b1, from the multipoint connection management table 106. The directory management unit 62 returns the information to the electronic conference management unit 34 (step 568).

The electronic conference management unit 34 specifies the obtained MCU address c, and notifies the electronic conference control unit 36 to be connected with the multipoint connection unit 80. When the electronic conference control unit 36 receives the notification, the electronic conference control unit 36 specifies the multipoint connection unit 80 based on the MCU address c, and is connected with the multipoint connection unit 80 (step 570).

When the multipoint connection unit 80 is connected with the electronic conference terminal 30, the multipoint connection unit 80 obtains the IP address b. Then, the multipoint connection unit 80 requests the MCU address and the group that correspond to the IP address b from the directory management unit 62. As a result, the MCU address cl and the group c-g1 are obtained.

Next, the multipoint connection unit 80 notifies the directory management unit 62 to obtain the IP address corresponding to the combination of the MCU address c1 and the group c-g1. At this time point, because the IP address a of the electronic conference terminal 20 and the IP address b of the electronic conference terminal 30 are registered in the multipoint connection management table 106, the directory management unit 62 obtains each of the IP addresses a and b, and returns them to the multipoint connection unit 80. Because each of the IP addresses a and b corresponds to the same MCU address c1 and the same group c-g1, the multipoint connection unit 80 judges that both of the IP addresses a and b are the IP addresses of the electronic conference terminals being the constituent members of the same electronic conference. Accordingly, the multipoint connection unit 80 connects the electronic conference terminal 20 with the electronic conference terminal 30. In this manner, each of the electronic conference terminals 20 and 30 are connected with each other via the multipoint connection unit 80.

With that, the state in which the cellular phone 40 and the cellular phone 50 are connected with each other can be switched to the state in which the electronic conference terminal 20 and the electronic conference terminal 30 are connected with each other.

In addition, although the description has been given, for the convenience of the description, on the assumptions that the processing executed by the electronic conference management unit 24 is executed prior to the processing executed by the electronic conference management unit 34, even if this order is reversed, the electronic conference terminal 20 and the electronic conference terminal 30 are connected with each other.

As described above, according to the present embodiment, the electronic conference terminal 20 can obtain the information for being connected with the electronic conference terminal 30 from the server 60 based on the telephone number of the cellular phone 50 that the cellular phone 40 holds. As a result, even if the identification information of the electronic conference terminal 30 is not transmitted from the cellular phone.50 to the cellular phone 40, the electronic conference terminal 20 can be connected with the electronic conference terminal 30.

### Embodiment 2

In an embodiment 2, a description is given for the case where the state is changed from the sate in which each of the electronic conference terminals 20 and 30 are connected with each other and the users A and B are carrying out an electronic conference, to the state in which the user A ends the use of the electronic conference terminal 20 and connects the cellular phone 40 with the electronic conference terminal. 30 to exchange information.

Such a situation occurs, for example, when the user A leaves the electronic conference terminal 20 to successively participate in the electronic conference from the cellular phone 40 in the state in which the electronic conference does not end within a time when the user A can use the electronic conference terminal 20, the electronic conference having been held between the user A using the electronic conference terminal 20 and the user B using the electronic conference terminal 30.

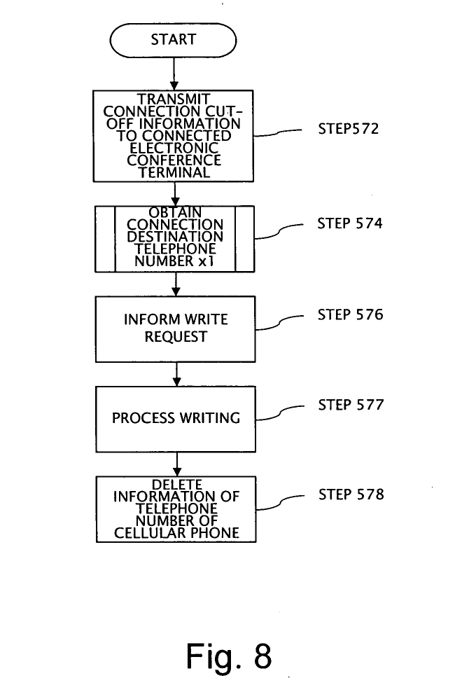

Hereinafter, by reference to FIG. 8, the description is given for the case where the state in which each of the electronic conference terminals 20 and 30 are connected with each other is switched to the state in which the user A participates in the electronic conference by connecting the cellular phone 40 with the electronic conference terminal 30.

FIG. 8 is a flowchart showing the flow of the processing of the electronic conference terminal 20 pertaining to a change of a state from the state in which the electronic conference terminal 20 is connected with the electronic conference terminal 30 to the state in which the user A transmits the information on a connection destination necessary to be connected with the electronic conference to the cellular phone 40.

The processing is started by the operation of the user A of the electronic conference terminal 20. As a result of the operation of the user A, it is notified to the electronic conference management unit 24 that the user A participates in the electronic conference with the cellular phone 40. The message notified to the electronic conference management unit 24 at this time is referred to as a cellular phone transition notification.

When the electronic conference management unit 24 receives the cellular phone transition notification, the electronic conference management unit 24 transmits a notification of the cut-off of the connection with the electronic conference terminal 30 to the electronic conference control unit 26. When the electronic conference control unit 26 receives the notification, the electronic conference control unit 26 transmits a previous cut-off notify to the electronic conference control unit 36 of the electronic conference terminal 30. When the electronic conference control unit 36 receives the previous cut-off notification, the electronic conference control unit 36 transmits a reception notification of the previous cut-off notification to the electronic conference management unit 34. The electronic conference management unit 34 receives the reception notification of the previous cut-off notification. The electronic conference control unit 26 has a role as a cut-off notifying unit notifying the electronic conference terminal 30 that is connected of the cut-off of the connection (step 572).

After that, the electronic conference management unit 24 obtains the telephone number x1 of the connection destination, which specifies the connection destination of the cellular phone 40. The electronic conference management unit 24 has a role as a connection destination information obtainment unit obtaining the connection destination telephone number x1 of the electronic conference management unit 24. In addition, the details of the determination method of the telephone number x1 of the connection destination willl be described later (step 574).

After the electronic conference management unit 24 has obtained the telephone number x1 of the connection destination, the electronic conference management unit 24 outputs a write request to the IC card reader writer 22. In response to the write request, the IC card reader writer 22 stands by in the state of a write request (step 576). Then, when the cellular phone 40 comes in the vicinity of the IC card reader writer 22, the IC card reader writer 22 writes the telephone number x1 into the short range communication IC 46. In this manner, the IC card reader writer 22 has a role as a terminal connection destination information transmission unit transmitting the telephone number x1 of the connection destination to the cellular phone 40 (step 577).

When the IC card reader writer 22 has completed the writing of the telephone number of the connection destination into the short range communication IC 46, the IC card reader writer 22 notifies the electronic conference management unit 24 of the completion of the write processing into the short range communication IC 46. After the reception of the notification, the electronic conference management unit 24 notifies the directory management unit 62 to delete the information corresponding to the telephone number a1 of the cellular phone 40. When the directory management unit 62 receives the notification, the directory management unit 62 deletes the information corresponding to the telephone number a1 from the electronic conference terminal information management table 104 (step 578).

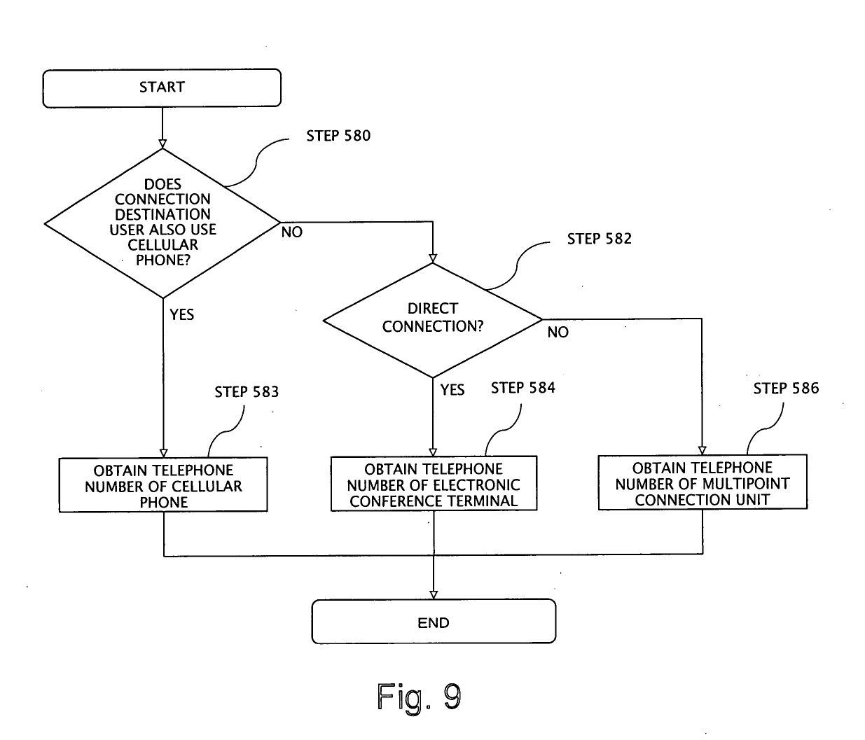

Successively, the details of the determination method of the telephone number x1 of the connection destination are described based on the flowchart of FIG. 9. FIG. 9 is a flowchart showing the procedure of the determination method.

After the processing of the step 572, when the electronic conference management unit 34 receives a previous connection ending notification from the electronic conference management unit 24, the electronic conference management unit 34 displays the information indicating that the electronic conference terminal 20 has received the cellular phone transition notification on the display screen of the electronic conference terminal 30. Together with the display, the electronic conference management unit 34 displays the information indicating whether to end the connection with the electronic conference terminal 30 to participate in the electronic conference with the cellular phone 50, or whether to continue the connection with the electronic conference terminal 30, and urges the user B to make a selection.

If the user B operates the electronic conference terminal 30 to select either of the two, the electronic conference management unit 34 transmits a previous connection ending response notification including the result that the user B has selected to the electronic conference management unit 24.

When the electronic conference management unit 24 receives the previous connection ending response notification of the user B, the electronic conference management unit 24 examines the result that the user B has selected (step 580).

In the case where the result that the user B has selected is “continuing the connection with the second electronic conference terminal 30”, the electronic conference management unit 24 ascertains the connection method of the electronic conference terminals 20 and 30 at the time of constituting the electronic conference. Because the connection method is expressed as the information statically set in each of the electronic conference terminals 20 and 30, the electronic conference management unit 24 obtains the contents of the settings (step 582).

In the case of the connection method connecting the electronic conference terminals 20 and 30 directly like the first and the second connection methods mentioned above, the electronic conference management unit 24 notifies the directory management unit 62 to obtain the telephone number of the electronic conference terminal 30 corresponding to the IP address b of the electronic conference terminal 30. When the directory management unit 62 receives the notification, the directory management unit 62 retrieves the telephone number b1 associated with the IP address b from the electronic conference terminal information management table 104, and returns the telephone number b1 to the electronic conference management unit 24. The telephone number b1 is the telephone number x1 of the connection destination (step 584).

On the other hand, in the case of the connection method of connecting the electronic conference terminals 20 and 30 via the multipoint connection unit 80 like the third connection method mentioned above, the electronic conference management unit 24 notifies the directory management unit 62 to obtain the telephone number of the IP address of the multipoint connection unit 80 corresponding to the IP address of the multipoint connection unit 80. When the directory management unit 62 receives the notification, the directory management unit 62 retrieves the telephone number c-1 of the multipoint connection unit 80 corresponding to the IP address of the multipoint connection unit 80 from the electronic conference terminal information management table 104, and returns the telephone number c-1 to the electronic conference management unit 24. The telephone number c-1 of the multipoint connection unit 80 is the telephone number x1 of the connection destination (step 586).

On the other hand, in the case where the result of the selection of the user B at the step 580 is “participating in the electronic conference with the second cellular phone 50”, the electronic conference management unit 24 notifies the directory management unit 62 to obtain the telephone number corresponding to the IP address b of the electronic conference terminal 30. In response to the notification, the directory management unit 62 retrieves the telephone number b1 of the cellular phone 50 corresponding to the IP address from the cellular phone information management table 102, and returns the retrieved telephone number b1 to the electronic conference management unit 24. The telephone number b1 is the telephone number x1 of the connection destination (step 583). In this manner, the telephone number x1 of the connection destination is determined inside the electronic conference terminal 20.

Next, the operation of the cellular phone 40 will be described.

After the processing at the step 576, when the user A brings the cellular phone 40 close to the IC card reader writer 22 of the electronic conference terminal 20, the IC card reader writer 22 writes the telephone number x1 of the connection destination into the short range communication IC 46.

After that, the user A operates the cellular phone 40 to notify the communication management unit 44 of being connected with the electronic conference with the cellular phone 40. When the communication management unit 44 receives the notice, the communication management unit 44 obtains the telephone number x1 from the short range communication IC 46. Successively, the communication management unit 44 specifies the obtained telephone number x1 to the communication control unit 42 to make the communication control unit 42 execute transmission processing. In this manner, the cellular phone 40 is connected to the communication terminal specified by the telephone number x1. In addition, in the present embodiment, the communication terminal specified by the telephone number x1 of the connection destination is any one of the cellular phone 50, the electronic conference terminal 30 and the multipoint connection unit 80.

As described above, according to the present embodiment, the telephone number of the communication terminal of the connection destination can be notified to the cellular phone 40. Consequently, the user A can continue to participate in an electronic conference using the cellular phone 40 even after ending the use of the electronic conference terminal 20.

In the present embodiment, a database is used as a memory holding unit in the terminal identification information management unit managing the connection information such as the IP address of each of the electronic conference terminals 20 and 30 and the telephone number of each of the cellular phones 40 and 50. Any storage unit capable of storing the identification information of a communication terminal can be used as the connection information storage unit. For example, a primary storage device such as a memory built into the server or a text file may be used as the connection information storage unit.

In the present embodiment 1, the contents of the directory database 64 are registered at the time of using the electronic conference terminal, and are deleted at the time of leaving the electronic conference terminal. However, the contents of the directory database 64 may have been previously input, and may be preserved as they are. For example, in the case where the user (each of the cellular phones 40 and 50) using each of the electronic conference terminals 20 and 30 is fixed, even if the contents of the input directory database 64 are fixed, it is possible for one electronic conference terminal to obtain the information communication terminal identification information on the electronic conference terminal of the connection target, and to be connected with the electronic conference terminal of the connection target.

Although the cellular phone 40 is used as the mobile communication terminal in each embodiment, the mobile communication terminal is not limited to the cellular phone, but may be any communication terminal as long as the communication terminal is portable. Any communication terminals may be used as long as the communication terminals can carry out communication even if the communication terminals are distant from the electronic conference terminal 20.

Moreover, although the cellular phone 40 is connected with the electronic conference terminal 30 through the telephone network 92 in the present embodiment, the cellular phone 40 may be connected with the electronic conference terminal 30 without putting the telephone network 92 between them. For example, the cellular phone 40 may be connected with the electronic conference terminal 30 through an IP network like a packet telephone.

Although the cellular phone corresponding to the electronic conference terminal 20 is only the cellular phone 40, plural cellular phones can be used as the cellular phone in the embodiment 1. That is, in the state in which the electronic conference terminals 20 and 30 have already been connected with each other, it is possible to add the cellular phones associated with the electronic conference terminal 20 one by one.

In the embodiment 2, even in the case where one person leaves the electronic conference terminal 20 to participate in the electronic conference using the cellular phone 20 from the state in which plural cellular phones correspond to the electronic conference terminal 20, namely from the state in which plural participants use the electronic conference terminal 20, the electronic conference terminal 20 can transmit the telephone number of the connection destination to which the cellular phone 40 should be connected with, to the cellular phone 40.

Moreover, a connection switching program of the present invention is to perform a function of the second information communication terminal, the function including: a second obtainment unit that obtains the identification information of the first mobile communication terminal from the second mobile communication terminal; and a second connection destination information management unit that sends a registration request to the terminal identification information management unit to register the identification information of the second information communication terminal in correspondence with the identification information of the second mobile communication terminal.

Moreover, in a connection switching program of the present invention, the first connection destination information management unit sends a registration request to the terminal identification information management unit to make the terminal identification information management unit register the identification information of the first information communication terminal in correspondence with the identification information of the first mobile communication terminal; and the second connection destination information management unit sends a registration request to the terminal identification information management unit to make the terminal identification information management unit register the identification information of the second information communication terminal in correspondence with the identification information of the second mobile communication terminal, sends an obtainment request to the terminal identification information management unit to obtain the identification information of the first information communication terminal corresponding to the identification information of the first mobile communication terminal, which is registered by the first connection destination information management unit, and specifies the identification information of the first information communication terminal, the identification information obtained from the terminal identification information management unit, to be connected with the first information communication terminal through the communication network.

Moreover, in a connection switching program of the present invention, the terminal connection information is information to be connected with the second mobile communication terminal, or information to be connected with the second information communication terminal.

Moreover, in a connection switching program of the present invention, the terminal connection information is information to be connected with the second mobile communication terminal, or information to be connected with the multipoint connection unit connected with the first information communication terminal.

It should be noted, however, the present invention is not limited to the specific embodiments described in the present specification.

What is claimed is:

1. A storage medium readable by a computer, the storage medium storing a connection switching program to perform a function of a first information communication terminal included in an electronic conference system including:
the first information communication terminal;
a second information communication terminal;
a first mobile communication terminal capable of information interchange with the first information communication terminal;
a second mobile communication terminal that is capable of information interchange with the second information communication terminal, and has identification information to be held by the first mobile communication terminal; and
a storage unit that stores identification information of each of the information communication terminals in associated with identification information of each of the mobile communication terminals; the function comprising:
obtaining the identification information of the second mobile communication terminal from the first mobile communication terminal;
obtaining the identification information of the second information communication terminal which corresponds to obtained the identification information of the second mobile communication terminal from the storage unit; and
connecting with the second information communication terminal through a communication network, based on the obtained identification information of the second information communication terminal.

2. The storage medium according to claim 1, wherein the program is further to perform a function of the second information communication terminal, the function comprising:
obtaining the identification information of the first mobile communication terminal from the second mobile communication terminal; and
registering the identification information of the second information communication terminal in associated with the identification information of the second mobile communication terminal.

3. The storage medium according to claim 2, wherein
the identification information of the first information communication terminal is registered correspondingly to the identification information of the first mobile communication terminal by the first information communication terminal;
the identification information of the second information communication terminal is registered in associated with the identification information of the second mobile communication terminal by the second information communication terminal; and
the second information communication terminal obtains the identification information of the first information communication terminal which corresponds to the identification information of the first mobile communication terminal, which is registered by the first information communication terminal, and
connects with the first information communication terminal through the communication network based on the obtained identification information of the first information communication terminal.

4. A storage medium storing a connection switching program to perform a function of a first information communication terminal, a second information communication terminal and a multipoint connection unit, all included in an electronic conference system including:
the first information communication terminal;
the second information communication terminal;
a first mobile communication terminal capable of information interchange with the first information communication terminal;
a second mobile communication terminal that is capable of information interchange with the second information communication terminal, and has identification information to be held by the first mobile communication terminal;
the multipoint connection unit to be connected with the communication terminals used by constituent members of an electronic conference; and
a storage unit that stores identification information of each of the mobile communication terminals in association with identification information of the multipoint connection unit used for connection;
the function relative to the first information communication terminal comprising:
obtaining each of the identification information of the first and the second mobile communication terminals from the first mobile communication terminal; and
registering the identification information of the first mobile communication terminal, the identification information of the first information communication terminal, and the identification information of the second mobile communication terminal in correspondence with identification information of the multipoint connection terminal, in the storage unit;
the function relative to the second information communication terminal comprising:
obtaining each of the identification information of the first and the second mobile communication terminals from the second mobile communication terminal; and
registering the identification information of the second information communication terminal which corresponds with the identification information of the second mobile communication terminal in the storage unit; and
the function relative to the multipoint connection unit comprising:
obtaining each of the identification information of the first and the second information communication terminals which corresponds to the identification information of the multipoint connection terminal, from the storage unit; and
connecting the first information communication terminal specified by the identification information of the first information communication terminal with the second information communication terminal specified by the identification information of the second information communication terminal, both the identification information being obtained from the storage unit.

5. A storage medium storing a connection switching program to perform a function of a first information communication terminal included in an electronic conference system including:
the first information communication terminal;
a second information communication terminal connected with the first information communication terminal through a communication network;
a first mobile communication terminal capable of information interchange with the first information communication terminal;
a second mobile communication terminal capable of information interchange with the second information communication terminal; and
a storage unit that stores terminal connection information specifying a connection destination of the first mobile communication terminal in associated with the identification information of each of the information communication terminals;
the function comprising:
obtaining terminal connection information which corresponds to the identification information of the second information communication terminal; and
transmitting the obtained terminal connection information to the first mobile communication terminal in order to make the first mobile communication terminal place a call.

6. The storage medium according to claim 5, wherein
the terminal connection information is information for connecting with the second mobile communication terminal, or information for connecting with the second information communication terminal.

7. A storage medium storing a connection switching program to perform a function of a first information communication terminal included in an electronic conference system including:
a multipoint connection unit;
the first information communication terminal connected with the multipoint connection unit through a communication network;
a second information communication terminal connected with the first information communication terminal through the multipoint connection unit;
a first mobile communication terminal capable of information interchange with the first information communication terminal;
a second mobile communication terminal capable of information interchange with the second information communication terminal; and
a storage unit that stores terminal connection information specifying a connection destination of the first mobile communication terminal in association with identification information of the multipoint connection unit; the function comprising:
obtaining terminal connection information which corresponds to identification information of the second information communication terminal; and
transmitting the obtained terminal connection information to the first mobile communication terminal in order to make the first mobile communication terminal place a call.

8. The storage medium according to claim 7, wherein
the terminal connection information is information for connecting with the second mobile communication terminal, or information for connecting with the multipoint connection unit connected with the first information communication terminal.

9. An electronic conference system comprising:
a first information communication terminal;
a second information communication terminal;
a first mobile communication terminal capable of information interchange with the first information communication terminal;
a second mobile communication terminal that is capable of information interchange with the second information communication terminal, and has identification information to be held by the first mobile communication terminal;
a storage unit that stores identification information of each of the information communication terminals in associated with identification information of each of the mobile communication terminals;
a first obtainment unit that obtains the identification information of the second mobile communication terminal from the first mobile communication terminal;
a second obtainment unit that obtains the identification information of the second information communication terminal which corresponds to the obtained identification information of the second mobile communication terminal from the storage unit; and
an information communication terminal connection unit that connects the first information communication terminal with the second information communication terminal through a communication network based on the obtained identification information of the second information communication terminal.

10. An electronic conference system including:
a first information communication terminal;
a second information communication terminal;
a first mobile communication terminal capable of information interchange with the first information communication terminal;
a second mobile communication terminal that is capable of information interchange with the second information communication terminal, and has identification information to be held by the first mobile communication terminal;
a multipoint connection unit to which communication terminals used by constituent members of an electronic conference are connected;
a storage unit that stores identification information of the multipoint connection unit used for connection in associated with identification information of each of the mobile communication terminals;
a first obtainment unit that obtains each of the identification information of the first and the second mobile communication terminals from the first mobile communication terminal;
a first connection management unit that registers the identification information of the first mobile communication terminal, the identification information of the first information communication terminal, and the identification information of the second mobile communication terminal in correspondence with identification information of multipoint connection terminal in the storage unit;
a second obtainment unit that obtains each of the identification information of the first and the second mobile communication terminals from the second mobile communication terminal;
a second connection management unit that registers the identification information of the second information communication terminal which corresponds to the identification information of the second mobile communication terminal in the storage unit;
a connection object obtainment unit that obtains each of the identification information of the first and the second information communication terminals which corresponds to the identification information of the multipoint connection terminal, from the storage unit; and
an information communication terminal connection unit that connects the first information communication terminal specified by the identification information of the first information communication terminal with the second information communication terminal specified by the identification information of the second information communication terminal, both the identification information being obtained from the storage unit.

11. An electronic conference system comprising:
a first information communication terminal;
a second information communication terminal connected with the first information communication terminal through a communication network;
a first mobile communication terminal capable of information interchange with the first information communication terminal;
a second mobile communication terminal capable of information interchange with the second information communication terminal;
a storage unit that stores terminal connection information specifying a connection destination of the first mobile communication terminal in associated with the identification information of each of the information communication terminals;
an obtainment unit that obtains terminal connection information which corresponds to the identification information of the second information communication terminal; and
a transmission unit that transmits the obtained terminal connection information to the first mobile communication terminal in order to make the first mobile communication terminal place a call.

12. An electronic conference system comprising:
a multipoint connection unit;
a first information communication terminal connected with the multipoint connection unit through a communication terminal;
a second information communication terminal connected with the first information communication terminal through the multipoint connection unit;
a first mobile communication terminal capable of information interchange with the first information communication terminal;
a second mobile communication terminal capable of information interchange with the second information communication terminal;
a storage unit that stores terminal connection information specifying a connection destination of the first mobile communication terminal in associated with identification information of the multipoint connection unit;
an obtainment unit that obtains terminal connection information which corresponds to the identification information of the multipoint connection unit; and
a transmission unit that transmits the obtained terminal connection information to the first mobile communication terminal in order to make the first mobile communication terminal place a call.

13. A connection switching method in a first information communication terminal of an electronic conference system including:
the first information communication terminal;
a second information communication terminal;
a first mobile communication terminal capable of information interchange with the first information communication terminal;
a second mobile communication terminal that is capable of information interchange with the second information communication terminal, and has identification information to be held by the first mobile communication terminal; and
a storage unit that stores identification information of each of the information communication terminals in associated with identification information of each of the mobile communication terminals; the method comprising:
obtaining the identification information of the second mobile communication terminal from the first mobile communication terminal;
obtaining the identification information of the second information communication terminal which corresponds to the obtained identification information of the second mobile communication terminal from the storage unit; and
connecting the first information communication terminal with the second information communication terminal through a communication network based on the obtained identification information of the second information communication terminal.

14. A connection switching method in a first information communication terminal of an electronic conference system including:
the first information communication terminal;
a second information communication terminal connected with the first information communication terminal through a communication network;
a first mobile communication terminal capable of information interchange with the first information communication terminal;
a second mobile communication terminal capable of information interchange with the second information communication terminal; and
a storage unit that stores terminal connection information specifying a connection destination of the first mobile communication terminal in association with identification information of each of the information communication terminals;
the method comprising:
obtaining terminal connection information which corresponds to the identification information of the second information communication terminal; and
transmitting the obtained terminal connection information to the first mobile communication terminal in order to make the first mobile communication terminal place a call.
